(19) United States
(12) Patent Application Publication
(10) Pub. No.: US 2023/0269321 A1
(43) Pub. Date: Aug. 24, 2023

(54) SYSTEMS AND METHODS FOR VOICE MESSAGING INTERFACES AND INTERACTIONS

(71) Applicant: YATTER PTY LTD, Fitzroy North (AU)

(72) Inventor: Geoffrey Kirkcaldie-Bowell, Fitzroy North (AU)

(21) Appl. No.: 18/172,259

(22) Filed: Feb. 21, 2023

Related U.S. Application Data
(60) Provisional application No. 63/312,597, filed on Feb. 22, 2022.

(51) Int. Cl. H04M 1/72433; G06F 16/683; G06F 3/04817; G06F 3/16

(52) U.S. Cl. CPC H04M 1/72433; G06F 3/04817; G06F 3/165; G06F 16/683

(57) ABSTRACT

Various embodiments of the present application are directed towards systems and methods for presenting a primary user on a primary user device with a first interface for asynchronous voice conversation transmission. The methods and systems may further include selecting a target user from the first interface, presenting a second interface for recording a first snippet of a conversation, presenting the primary user an option to begin recording the first snippet of the conversation, receiving a selection by the primary user to begin recording the first snippet of the conversation, recording the first snippet of the conversation to an audio data file and updating the second interface in response to the primary user’s speech. Automatically, upon receiving the selection from the primary user to stop recording of the first snippet of the conversation, the system may transmit to a cloud server the audio data file with a set of metadata.

### CROSS REFERENCE TO RELATED APPLICATIONS

This Application is a Continuation of provisional U.S. Application No. 63/312,597, filed on Feb. 22, 2022, the contents of which are incorporated herein by reference in their entirety.

### BACKGROUND

Users are demanding more and more international and cross country interactions with their friends and colleagues. Most of todays communications systems are limited to live video or audio, or text messaging in a play-as-you-go format. With the increased demand of digital and international communications there exists no systems with natural-flow communications types for asynchronous conversations. For example, normal live conversations are typically one orator speaking after the other. This sequence of back-and-forth is not typically captured with any of today’s existing systems when a conversation is not live. There exists a need therefore for a natural language communication system for users to more freely enjoy their asynchronous contacts with other users across the globe.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

In one aspect, a method includes presenting a primary user on a primary user device with a first interface for asynchronous voice conversation transmission, selecting a target user from the first interface, presenting a second interface for recording a first snippet of a conversation, presenting the primary user an option to begin recording the first snippet of the conversation, receiving a selection by the primary user to begin recording the first snippet of the conversation, recording the first snippet of the conversation to an audio data file and updating the second interface in response to the primary user’s speech, receiving a selection from the primary user to stop recording of the first snippet of the conversation, and automatically upon receiving selection from the primary user to stop recording of the first snippet of the conversation, transmitting to a cloud server the audio data file with a set of metadata associated with the audio data file to be stored on the cloud server and then transmitted to the target user device.

The method may also include receiving a second snippet of the conversation from the cloud server which was recorded on the target user device, presenting a notification to the primary user indicating receipt of the second snippet from the target user, upon selection of the notification automatically retrieving the second snippet and presenting the second snippet in a third interface, receiving a selection to play the second snippet in the third interface by the primary user, playing back the second snippet of the conversation in the third interface, upon finishing playback of the second snippet, automatically beginning recording of a third snippet of the conversation as a result of finishing playback, and upon receiving a selection to finish recording of the third snippet, automatically transmitting the third snippet to the cloud server for storage and transmission to the target user device.

The method may also include presenting the primary user with the first interface subsequent to the recording of the first snippet, receiving a selection of the target user from the first interface, presenting the second interface for recording a second snippet of the conversation by the primary user, presenting the primary user an option to begin recording the second snippet of the conversation, receiving a selection by the primary user to begin recording the second snippet of the conversation, recording the second snippet of the conversation to a new audio data file, and automatically upon receiving a selection from the primary user to stop recording of the second snippet of the conversation, transmitting to the cloud server the new audio data file with a new set of metadata associated with the new audio data file, to be stored on the cloud server and then transmitted to the target user device.

The method may also include where the primary user is presented with an option to end the conversation after the first snippet or a subsequent snippet recording; and upon receiving a selection to end the conversation, updating a conversation User Interface to include the first snippet and subsequently recorded snippets as part of a visually continuous conversation.

The method may also include where presenting the primary user an option to begin recording the first snippet of the conversation includes presenting audio controls for the conversation including a record button, allowing the primary user to touch the screen to begin recording of the first snippet.

The method may also include where storing on the cloud server further includes creating a new conversation, updating a relationship between the primary user and the target user, adding an item document for the audio data file, and transmitting a notification to the target user with the audio data file being transmitted.

The method may also include where the metadata includes an audio length of the first snippet, the target user it is being sent to, a timestamp, and the primary user identity.

The method may also include where selecting a target user from the interface further includes presenting the primary user a Graphical User Interface (GUI) with an image icon for each contact of the primary user, and selecting the target user includes presenting a full screen image of the image icon on the second interface. Other technical features may be readily apparent to one skilled in the art from the following figures, descriptions, and claims.

In one aspect, a method includes presenting a user interface on a device with a touch sensitive grid which includes horizontal x coordinates, and vertical y coordinates as part of the touch sensitive grid, where the volume level of the device is indicated as a percentage relative to the horizontal x coordinate indicated by a user touch anywhere on the screen, taking into account the horizontal x coordinate, and upon receiving a touch input on the device, changing the volume of the device relative to the x coordinate which was previously selected as a percentage of the volume.

The method may also include where the user interface is presented during playback of an audio file and the volume changes with respective screen touches indicating changes in volume. Other technical features may be readily apparent to one skilled in the art from the following figures, descriptions, and claims.

The method may also include where an icon is presented to the user at the point of touch, indicating the volume is changing.

The method may also include where the icon is an image of a speaker. Other technical features may be readily apparent to one skilled in the art from the following figures, descriptions, and claims.

### BRIEF DESCRIPTION OF THE SEVERAL VIEWS OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates an exemplary system environment in accordance with some embodiments.

FIG. 2A illustrates an exemplary system flow in accordance with some embodiments.

FIG. 2B illustrates an exemplary system flow in accordance with some embodiments.

FIG. 3 illustrates an exemplary system flow in accordance with some embodiments.

FIG. 4 illustrates an exemplary system flow in accordance with some embodiments.

FIG. 5 illustrates an exemplary user contacts GUI in accordance with some embodiments.

FIG. 6 illustrates an exemplary user conversation GUI in accordance with some embodiments.

FIG. 7 illustrates a conversation audio snippet playback in accordance with some embodiments.

FIG. 8 illustrates a conversation audio snippet playback in accordance with some embodiments.

FIG. 9 illustrates a conversation audio snippet playback in accordance with some embodiments.

FIG. 10 illustrates a conversation audio snippet playback in accordance with some embodiments.

FIG. 11 illustrates a conversation audio snippet playback in accordance with some embodiments.

FIG. 12 illustrates a countdown to speak User Interface (UI) in accordance with some embodiments.

FIG. 13 illustrates a countdown to speak UI in accordance with some embodiments.

FIG. 14 illustrates a recording audio conversation snippet UI in accordance with some embodiments.

FIG. 15 illustrates a recording audio conversation snippet UI in accordance with some embodiments.

FIG. 16 illustrates a recording audio conversation snippet UI in accordance with some embodiments.

FIG. 17 illustrates a recording audio conversation snippet UI in accordance with some embodiments.

FIG. 18 illustrates an audio transmission UI in accordance with some embodiments.

FIG. 19 illustrates an audio transmission UI in accordance with some embodiments.

FIG. 20 illustrates an exemplary screen capable volume changing GUI in accordance with some embodiments.

FIG. 21 is an example schematic diagram of a system according to some embodiments.

### DETAILED DESCRIPTION

It is important to note that the embodiments disclosed are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Embodiments of the present invention include novel forms of voice messaging interfaces and interactions. In some embodiments users may have friends that they have conversations with in a back and forth seamless pattern. Users may have mutual friends in an application which they can create, keep, and maintain conversations with. For example, some users may have conversations stored with each audio snippet or part of the conversations stored as a separate section for playback of individual segments of the conversation which were transmitted over the internet and stored on one or more cloud servers.

In one embodiment a user may open an application on a device such as a smartphone initiating a listening session in a database on the user device. The application may load other users or friends from the user device to a home screen interface. The user may select one of the users from their home screen. In some embodiments a full photo of the target user may cover the screen and audio recording controls may appear. The user may select a record button causing conversation controls to appear in a recording interface. The user may then speak or dictate a message where the recording interface reacts to the audio input with lines or bars indicating volume and pitch of speech. The user may then select to stop recording, and upon selection of the stopping the device may automatically send the recording to the target user. In this way a new conversation has been started on the user device. The device may then upload the audio data along with metadata to one or more cloud servers. The metadata may include that audio length, the target user (ID, for example), a timestamp, and the ID of the sending user. The Cloud server may then add a new conversation to its database, update the relationship for the user and the target user, and send a notification to the target user along with (or separate from) the audio file.

In one embodiment, a user may have the application closed and notifications turned on and then receive a notification when a recording is received. The user may then enter the application which begins the database listener session on the device. The application may automatically go to the account where the notification was received from and the user data may be loaded. A photo of the other user may be displayed and the current conversation may be loaded on the local device. Audio playback and conversation controls may then appear. The user may select or tap and then playback of the recording received may occur once the audio has been downloaded. The playback interface may react to the audio output metering. Once playback has finished automatic recording may begin where the device begins recording upon playback finishing and/or a countdown is presented. The recording interface may appear where a reaction to the audio input is presented. The user may then select to stop recording, and immediately upon recording stopping being selected, the audio may be transmitted to the other user. In this way the users are presented with a seamless conversation feeling like a continuous presentation or discussion. Audio recording controls may appear at the end of the recording to allow the user to record another conversation.

When a user has their notifications turned off they may receive a notification upon entering the application of a new audio snippet, or they may be presented with an icon indicating an updated conversation associated with the other user on the home page screen. When a user has the application opened and an audio file is received they may be presented with a notification and upon selecting the notification may be brought directly to playback of the new recording.

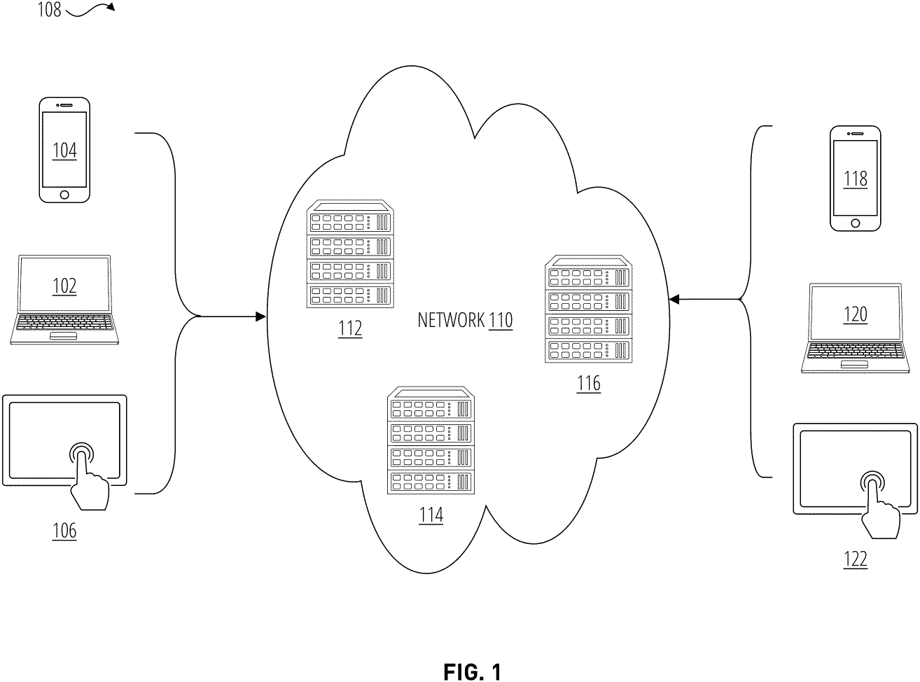

FIG. 1 illustrates an exemplary System Environment 108 in accordance with some embodiments. The System Environment 102 comprises a User Device 1 104-108, a Network 110, a Cloud server 112-116, and one or more Target user devices 118-122.

The User Device 1 104-108 and Target user device 118-122 may be, but is not limited to, a personal computer, a laptop, a tablet computer, a smartphone, a smart speaker a wearable computing device, or any other device capable of receiving and displaying notifications, receiving, playing and recording audio conversations. The Network 110 may be, but is not limited to, a wireless, cellular or wired network, a local area network (LAN), a wide area network (WAN), a metro area network (MAN), the Internet, the worldwide web (WWW), similar networks, and any combination thereof. Cloud server 112-116 may be any of one or more network server elements such as servers, containers, hypervisors, databases, relational database systems, cloud storage, Application Programming Interface (API) Gateways, controllers, managed data providers, open data providers/databases, serverless components, etc. The one or more Cloud server 112-116 may be at one or more geographic locations and used to store any elements of audio snippets or conversations and/or to transfer the audio elements without storing.

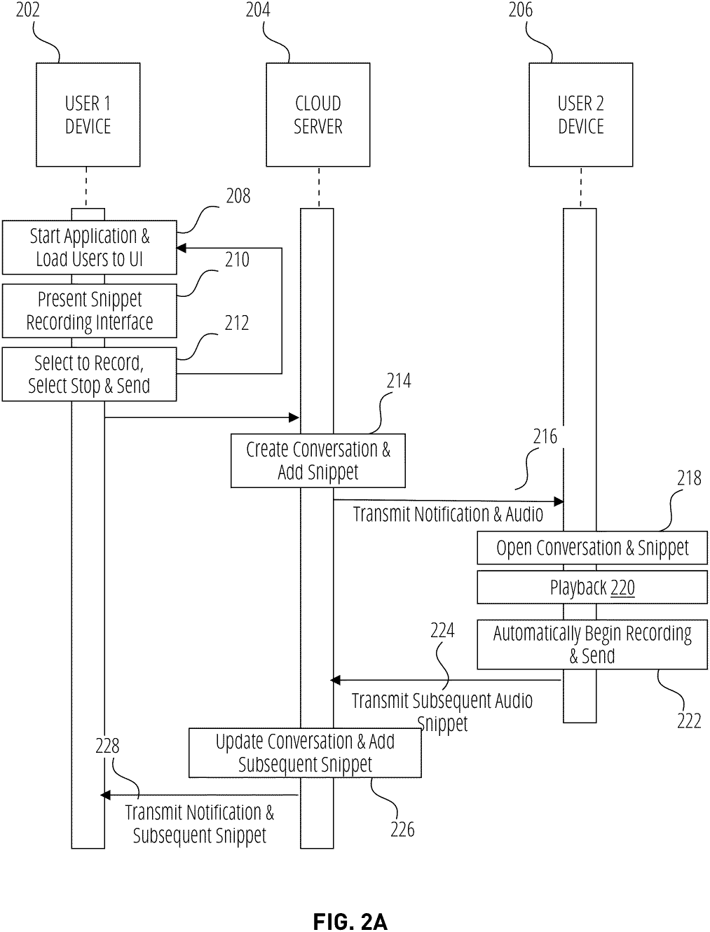

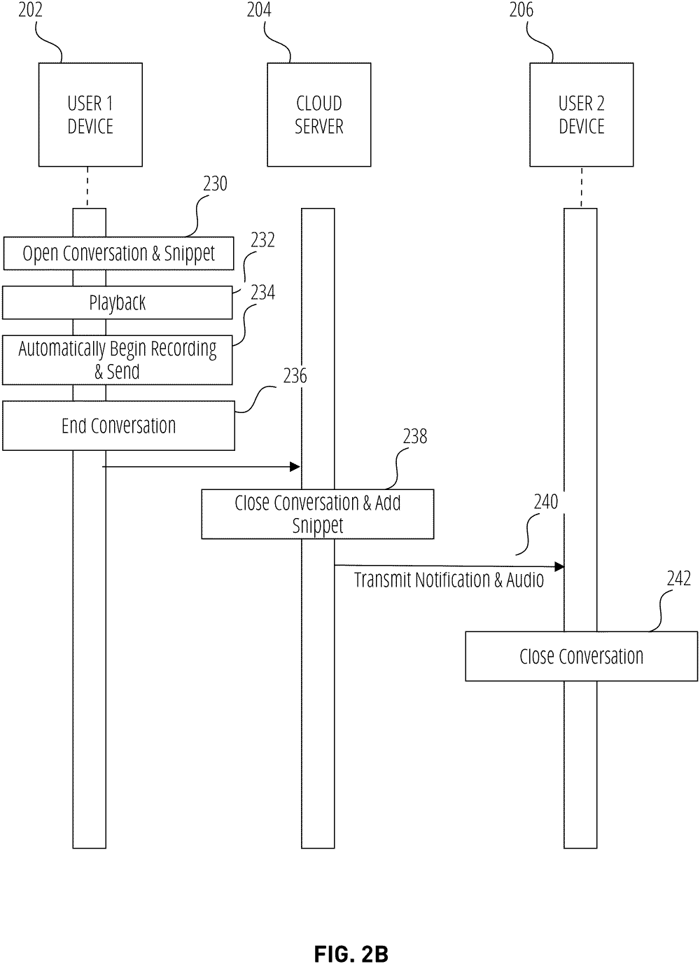

FIG. 2A illustrates an exemplary system flow in accordance with some embodiments. In some embodiments, User Device 1 202, may start the application and load users to the UI in step 208. The User Device 1 202 may then present a snippet recording interface in step 210. In step 212, User Device 1 202 may select to record an audio snippet. The audio snippet may be recorded, and then stopped by the user. Upon stopping the recording User Device 1 202 may automatically send the recording to Cloud Server 204. Cloud Server 204 may then Create a conversation on the cloud device, and add the snippet in step 214. In step 216, the Cloud Server 204 may Transmit a Notification and the snippet audio and metadata to User 2 Device 206.

User 2 Device 206 may then open the conversation and the audio snippet in step 218. User 2 Device 206 may then playback the audio snippet recorded on User Device 1 202 in step 220. User 2 Device 206 may automatically begin recording when the playback is done. After recording is done, User 2 Device 206 may then automatically send the audio file in step 222.

In step 224, the User 2 Device 206 may transmit the subsequent audio snippet to Cloud Server 204. Cloud Server 204 may update the conversation and add the subsequent snippet in step 226. In step 228, Cloud Server 204 may transmit a notification of then current subsequent snippet to User Device 1 202.

In FIG. 2B, the system continues from FIG. 2A. In step 230, the User Device 1 202, may open the conversation and snippet. In step 234, the User Device 1 202 may playback the snippet. In step 234 the User Device 1 202 may automatically begin recording upon the end of playback. Similarly, User Device 1 202 may automatically send the recording when recording was stopped by the user. In some embodiments, the user may end the conversation in step 236 as selected from the screen. When the conversation is ended by the user, the Cloud Server 204 may be notified. The Cloud Server 204 may update and close the conversation on the server and add the snippet in step 238. In step 240 the Cloud Server 204 may transmit a notification and the Audio snippet to User 2 Device 206. In step 242 User 2 Device 206 may close the conversation and update the conversation UI.

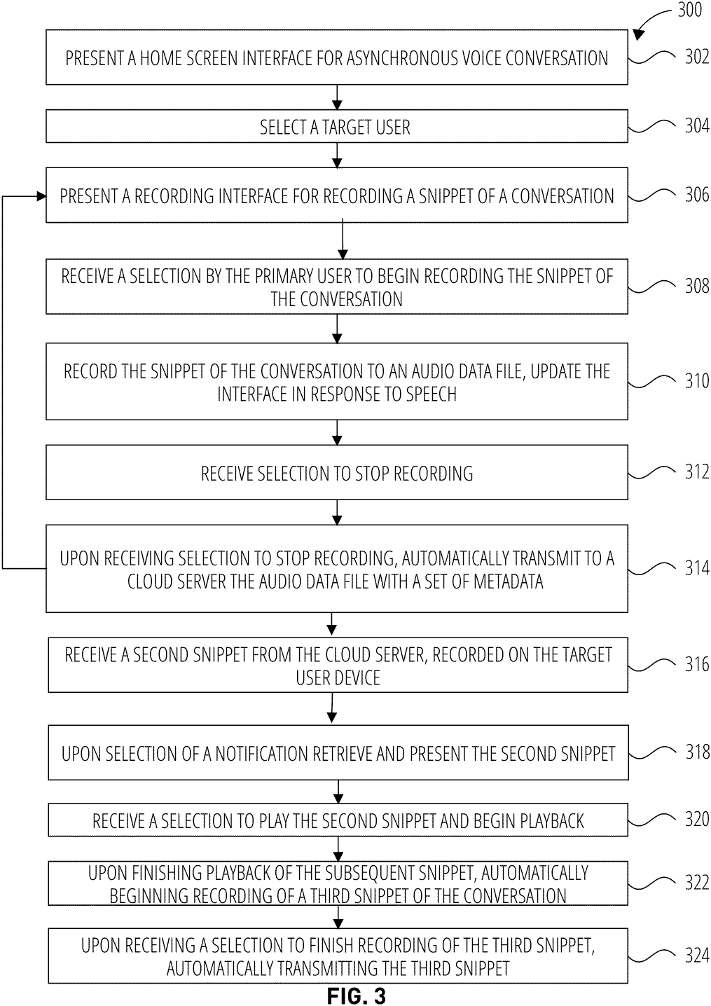

FIG. 3 illustrates an exemplary system flow in accordance with some embodiments. The user device may begin in step 302, where it presents a home screen interface for asynchronous voice conversation to the primary user. The home screen interface may be similar to that in FIG. 5. Users contacts or friends may be presented in a graphical format with their pictures or icons representing them for the user to choose to send, review or begin a conversation or snippet of a conversation.

In step 304, the user may select a target user from the list of users. In other embodiments, the user may be taken directly to a conversation or snippet screen when a snippet comes in while the application is open, or when a user selects to play an incoming snippet from an incoming notification outside of the application. The device may then proceed to step 306.

In step 306, the device may present a recording interface for recording a snippet of a conversation when a new conversation is being started or when no new snippet needs to be played. When a snippet was received and/or not heard yet, the user may be presented with the playback interface presented in FIGS. ’s6-12 instead of the recording interface. The device may then proceed to step 308.

In step 308, the device may receive a selection by the primary user to begin recording a snippet of the conversation. The selection may be made when the audio controls are present. The device may then proceed to step 310.

In step 310, the device may record the snippet of the conversation to an audio data file. The device may further update the interface in response to speech. For example, bars may reflect changes in tone or voice and volume. The device may then proceed to step 312.

In step 312, the device may receive a selection to stop recording. For example, the user may choose a stop button or press the screen to indicate finishing recording. The device may then proceed to step 314.

In step 314, upon receiving the selection to stop recording, the device may automatically transmit to a cloud server the audio data file with metadata. The transmission may occur in such a way that seems like a natural conversation taking place. The metadata may include the primary user identification, target user identification, and timestamp. The audio data and metadata may be stored on the cloud device, and the conversation and relationship of the user’s updated on the cloud servers as well. Additionally the cloud server may transmit a notification to the target user as well as the audio data. When the target user has recorded a second or subsequent snippet of audio the user device may proceed to step 316.

In some embodiments, when a user records the second, third or subsequent audio snippets before the target user records and sends their message audio, the device may return to step 306 where further recording takes place on the user device in a cyclical process. When the target user is the next to record an audio snippet, the device may proceed to step 316.

In step 316, the user device may receive a second snippet from the cloud server, recorded on the target user device. A notification may be presented to the user in a variety of formats.

In step 318, upon selection of the notification from the device home screen, or the application’s home screen, the user device may retrieve and present the second snippet to the user in a playback GUI. The device may then proceed to step 320.

In step 320, the user may receive a selection to play the second snippet and begin playback in the playback GUI. The second (or subsequent) snippet may be played back upon a selection of an audio control to play the audio. Toward the end of the playback the user may be presented with a countdown indicating recording will begin soon and playback is about to cease. The device may then proceed to step 322.

In step 322, upon finishing playback of the subsequent snippet, the device may automatically begin recording of a third (or additionally subsequent) snippet of the conversation. The recording may take place immediately after the countdown or playback of the recording such that a natural conversation feel is created. The device may then proceed to step 324.

In step 324, upon receiving a selection in the recording UI to finish recording of the third snippet, the device may automatically transmit the third snippet. The automatic transmission may occur in a fluid and conversational format similar to talking to somebody. In some embodiments users may continue by returning to step 306 and recording further snippets or waiting for a snippet to return from the other user in the conversation.

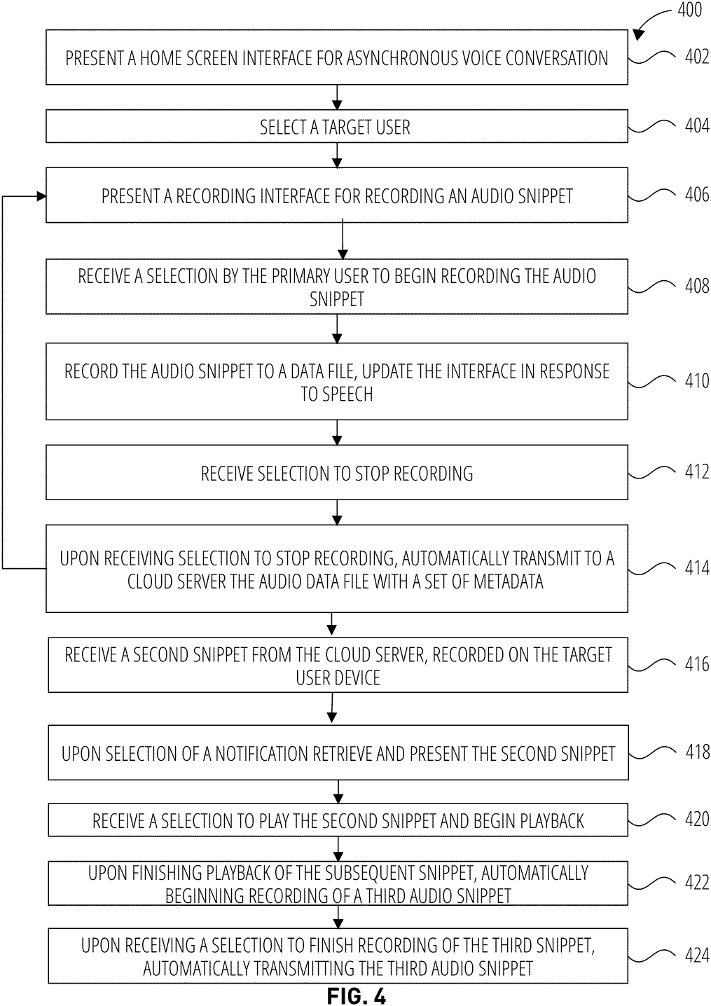

FIG. 4 illustrates an exemplary system flow in accordance with some embodiments. In this embodiment users may have audio recordings going back and forth between devices without a conversation being established. The user device may begin in step 402, where it presents a home screen interface for asynchronous audio snippets sent to the primary user. The home screen interface may be similar to that in FIG. 5. Users contacts or friends may be presented in a graphical format with their pictures or icons representing them for the user to choose to send, review or begin an audio snippet.

In step 404, the user may select a target user from the list of users. In other embodiments, the user may be taken directly to a snippet screen when an audio snippet comes in while the application is open, or when a user selects to play an incoming snippet from an incoming notification outside of the application. The device may then proceed to step 406.

In step 406, the device may present a recording interface for recording an audio snippet. When a snippet was received and/or not heard yet, the user may be presented with the playback interface presented in FIGS. ’s7-12 instead of the recording interface. The device may then proceed to step 408.

In step 408, the device may receive a selection by the primary user to begin recording an audio snippet. The selection may be made when the audio controls are present. The device may then proceed to step 410.

In step 410, the device may record the audio snippet to one or more data file types. The device may further update the interface in response to speech. For example, bars may reflect changes in tone or voice and volume. The device may then proceed to step 412.

In step 412, the device may receive a selection to stop recording. For example, the user may choose a stop button or press the screen to indicate finishing recording. The device may then proceed to step 414.

In step 414, upon receiving the selection to stop recording, the device may automatically transmit to a cloud server the audio data file with metadata. The transmission may occur in such a way that seems like a natural discussion taking place. The metadata may include the primary user identification, target user identification, and timestamp. The audio snippet, data file and metadata may be stored on the cloud device. The cloud server may transmit a notification to the target user as well as the audio or data file. When the target user has recorded a second or subsequent snippet of audio the user device may proceed to step 416.

In some embodiments, when a user records the second, third or subsequent audio snippets before the target user records and sends their message audio, the device may return to step 406 where further recording takes place on the user device in a cyclical process. When the target user is the next to record an audio snippet, the device may proceed to step 416.

In step 416, the user device may receive a second audio snippet from the cloud server, recorded on the target user device. A notification may be presented to the user in a variety of formats.

In step 418, upon selection of the notification from the device home screen, or the application’s home screen, the user device may retrieve and present the second audio snippet to the user in a playback GUI. The device may then proceed to step 420.

In step 420, the user may receive a selection to play the second audio snippet and begin playback in the playback GUI. The second (or subsequent) snippet may be played back upon a selection of an audio control to play the audio. Toward the end of the playback the user may be presented with a countdown indicating recording will begin soon and playback is about to cease. The device may then proceed to step 422.

In step 422, upon finishing playback of the subsequent snippet, the device may automatically begin recording of a third (or additionally subsequent) audio snippet. The recording may take place immediately after the countdown or playback of the recording such that a natural dialogue feel is created. The device may then proceed to step 424.

In step 424, upon receiving a selection in the recording UI to finish recording of the third snippet, the device may automatically transmit the third audio snippet. The automatic transmission may occur in a fluid and natural format similar to talking to somebody. In some embodiments users may continue by returning to step 406 and recording further audio snippets or waiting for a snippet to return from the other user. As such, in this embodiment users may interact seamlessly without the necessity of a recorded and tracked conversation.

FIG. 5 illustrates an exemplary user contacts GUI in accordance with some embodiments. As illustrated a user may have one or more friends displayed on a Home screen. The friends may be mutually accepted or may be populated from the user’s contact list. A user profile may be associated with the friends including an image of the person used to depict their account. A user may select a friend on the user contacts GUI and then be brought to either their conversations screen with that friend or be presented with the option of beginning a conversation with that friend.

FIG. 6 illustrates an exemplary user conversation GUI in accordance with some embodiments. Illustrated is an exemplary screen displaying conversations with one friend. As illustrated, each audio snippet may be stored and played back separately represented as differently colored circles in FIG. 6. In some embodiments, one color may represent the primary user and another color may represent the target user. If a user is sending multiple snippets without response that may be indicated with a series of circles of the same color. The user may be able to scroll up, down and left and right on the screen. The left and right scrolling may occur within a conversation to reveal more snippets in the conversation. A conversation may be begun and ended by either user, a third user or more participating in the conversation.

The conversations may be identified by time and date that the conversation was begun and finished and titles may be changed freely by the user. When a user wants to play back a conversation or a snippet from a conversation, they may select a circle (or other indicator for a snippet) and that snippet will playback, continuing playback of the next snippet. Therefore, the conversation represents a novel asynchronous feel of conversation between two or more individuals with the conversations recorded and played back as if one continuous conversation, although in reality the gap between snippets can be any duration of time.

For example, a user may record a snippet, automatically send and record the snippet. Their friend may respond with a recording and snippet, several hours later. The first user may then record the third snippet on the next day and send and record that snippet on a timeline of over 24 hours for just a few snippets. In the conversation the playback will seam seamless as if happening all in a short timeline, like a normal conversation.

In one example, when a user ends a conversation the following steps may take place on the user device:
1. User selects end conversation.
2. Current audio playback controls disappear.
3. Current conversation controls disappear.
4. The conversation is set to inactive.

The Conversation may be then updated on the cloud server and set to inactive. Similarly on the target user device the following may occur:
1. The conversation is set to inactive on the next open of the application.
2. The conversation controls do not appear upon opening the target user when conversation is inactive.
3. If the target user starts recording, the device also begins a new conversation.

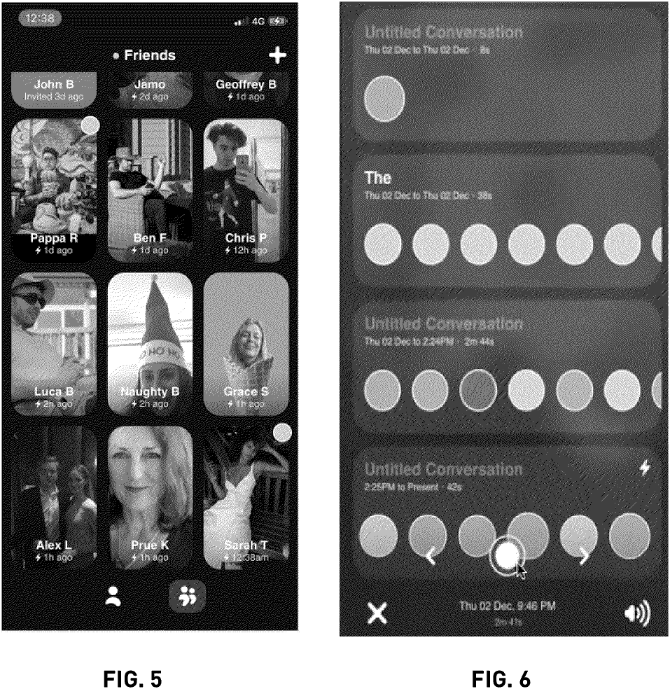

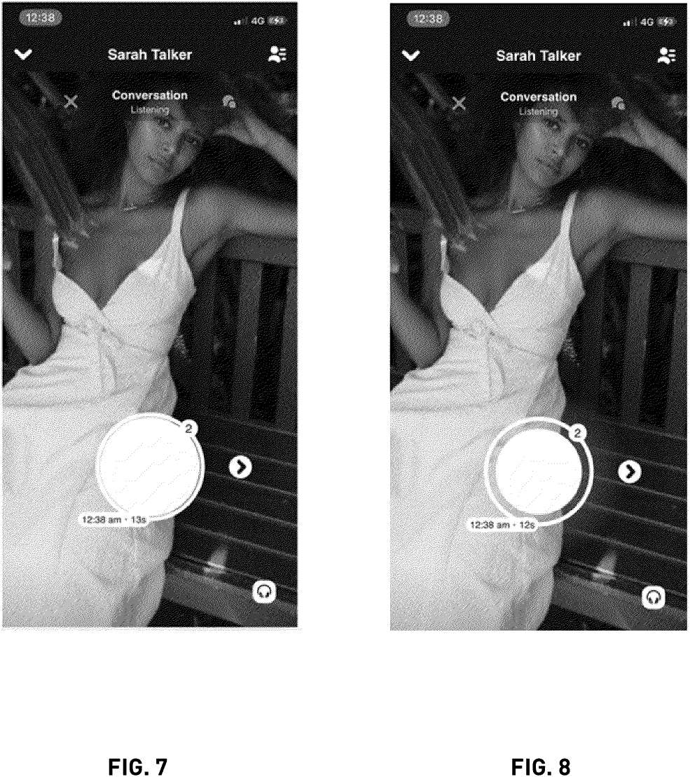

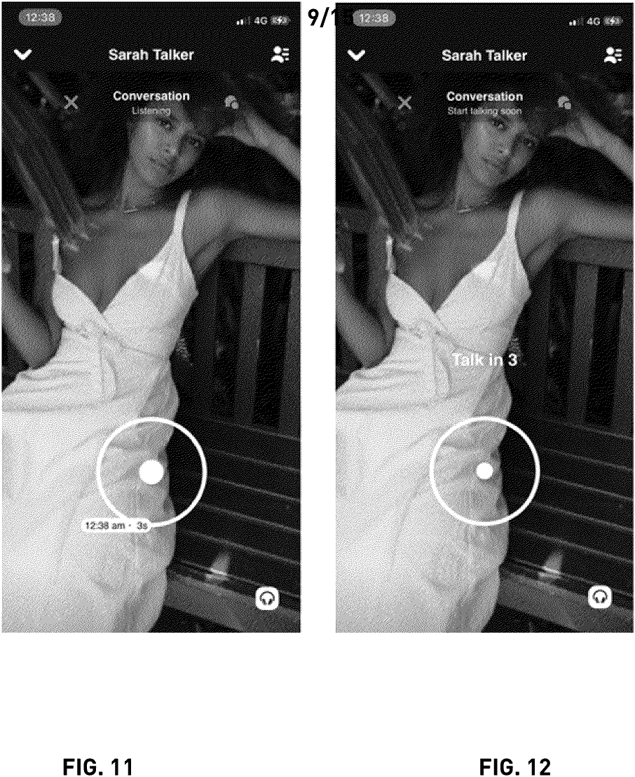

FIG. 7 illustrates a conversation audio snippet playback in accordance with some embodiments. In some embodiments users may playback automatically when a notification is selected and they are taken to the playback screen as illustrated in FIG. 7 when the application is closed. In another embodiment when the user has their notifications silenced, they may access the conversations by entering the application first and then a notification either implicitly, or as an icon on the friends image may indicate that a new conversation snippet was received. In another embodiment, when a user has the application open, they may receive a visual, audio or other notification that one or more snippets has just been received and then they can go to that conversation to hear back the new audio snippet. As such, the user is presented with many options of notifications to know that a friend has sent them a new audio snippet and their conversation has continued. FIG. 7 -FIG. 11 illustrate the beginning and continuation of audio playback of a snippet.

FIG. 8 illustrates a conversation audio snippet playback in accordance with some embodiments. In FIG. 8 the snippet has 12 seconds remaining and has already begun as indicated in the shaded circle that does not fully encompass the other circle as in FIG. 6.

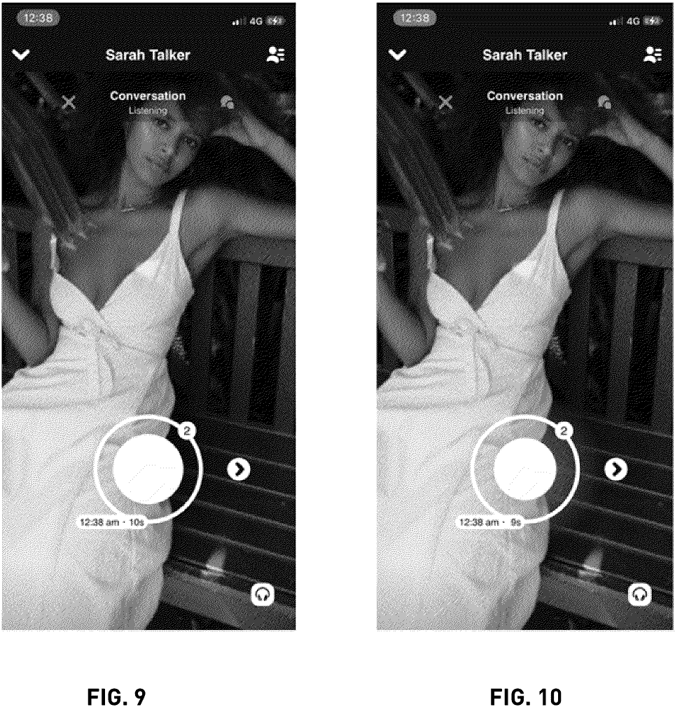

FIG. 9 illustrates a conversation audio snippet playback in accordance with some embodiments. In FIG. 9 the snippet has 10 seconds remaining of playback.

FIG. 10 illustrates a conversation audio snippet playback in accordance with some embodiments. In FIG. 10 the snippet has 9 seconds remaining of playback.

FIG. 11 illustrates a conversation audio snippet playback in accordance with some embodiments. In FIG. 11 the snippet has 3 seconds remaining of playback.

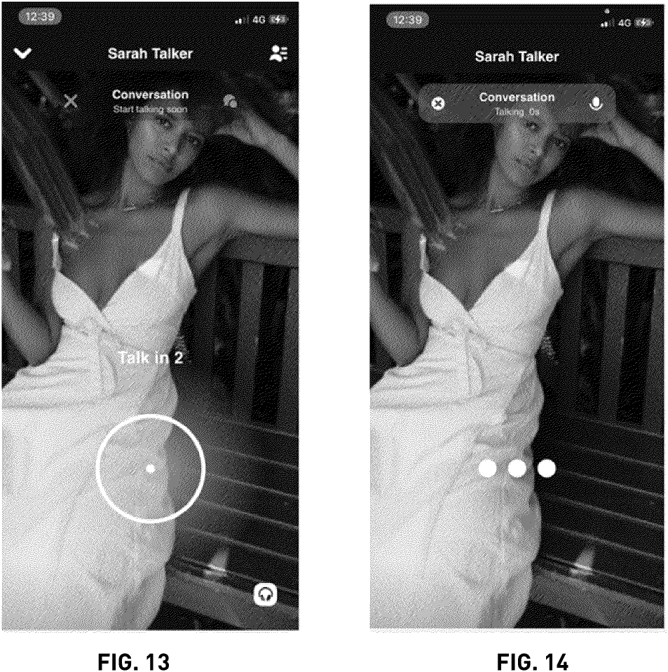

FIG. 12-FIG. 13 illustrate a countdown to speak UI in accordance with some embodiments. The UI indicates to the user to speak which is an automatic occurrence in response to the end of playback. In this way, the user has notification that he or she must speak and record a snippet automatically in response to the snippet received, thereby mimicking a natural conversation done in real time, however, being recorded asynchronously.

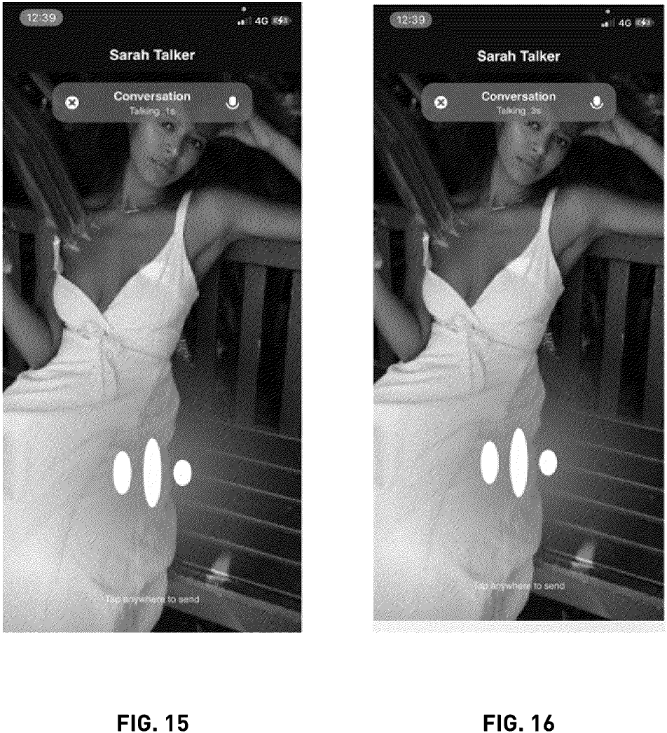

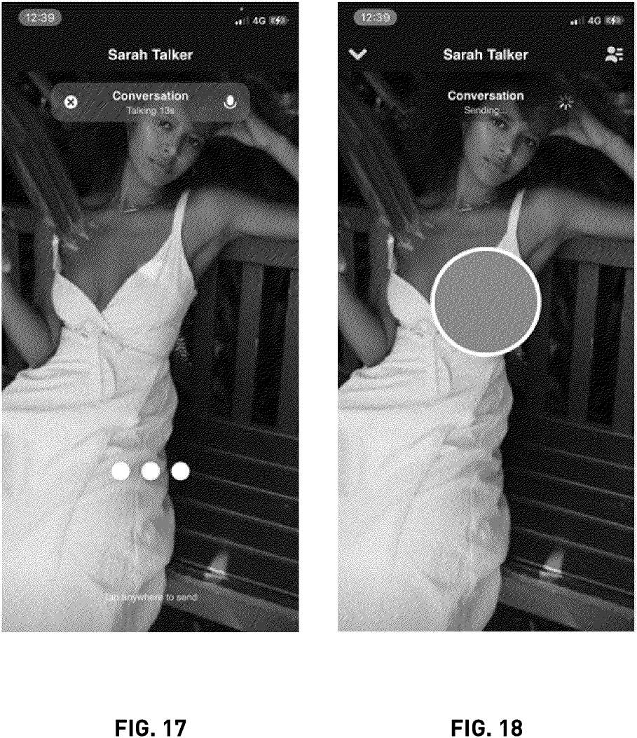

FIG. 14-FIG. 17 illustrate a recording audio conversation snippet UI in accordance with some embodiments. As illustrated immediately after playing back a snippet recording begins. The recording may have interaction or response to the user’s audio as illustrated in FIG. 15-FIG. 16. Similarly an indication of how long the conversation snippet is may be presented to the user anywhere on the screen.

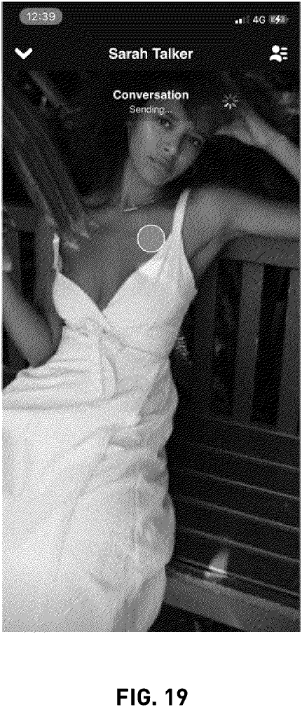

FIG. 18-FIG. 19 illustrate an audio transmission UI in accordance with some embodiments. As illustrated an animation of the transmission getting smaller and seeming as if it is being sent may be presented to the user.

FIG. 19 illustrates an audio transmission UI in accordance with some embodiments. As illustrated the recording indicator may be part of an animation visually demonstrating that the transmission is being sent.

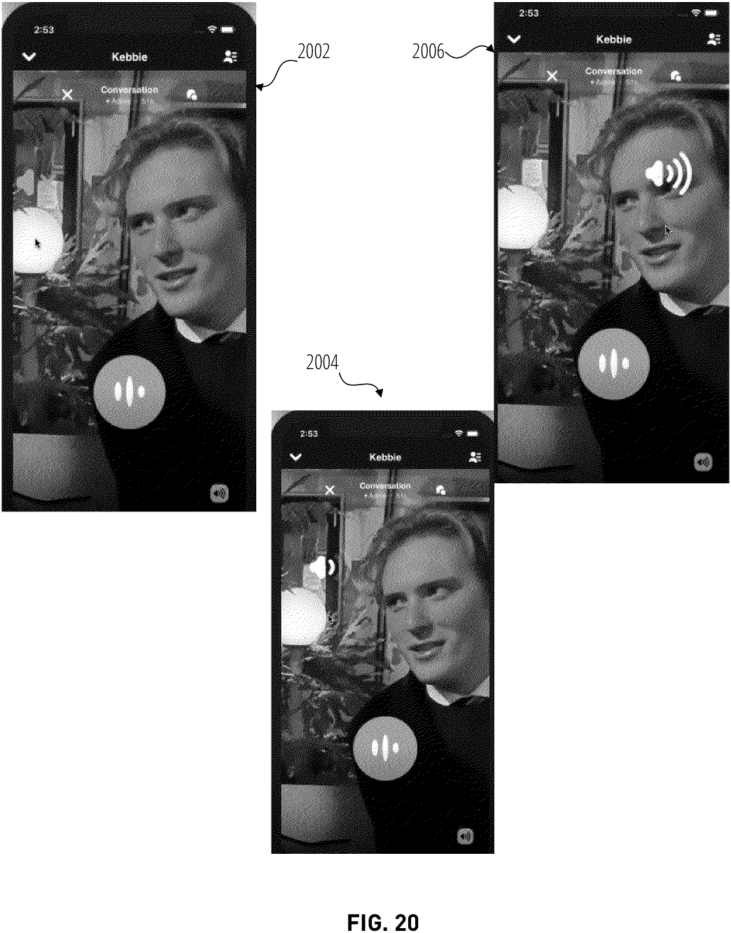

FIG. 20 illustrates an exemplary screen capable volume changing UI in accordance with some embodiments. FIG. 20 illustrates a Muted Volume Full Screen Touch Interaction 2002, a Low Volume Full Screen Touch Interaction 2004, and a High Volume Full Screen Touch Interaction 2006.

The screen may be broken down into horizontal and vertical grid points. As sensed by the device, the user may mark anywhere on the screen and the X or horizontal access may be detected. The X axis coordinate may be calculated as relative to the overall screen size and/or pixel dimension. Based on the horizontal position, the percentage between the left or right side of the screen may be converted to a voltage and/or sound meter.

For example, when a user presses toward 20% from the left of the screen, the volume may be automatically adjusted to 20% of the full volume of the system. Low Volume Full Screen Touch Interaction 2004 illustrates a volume at roughly 20% of the full volume of the system. Similarly, High Volume Full Screen Touch Interaction 2006 illustrates roughly 75% of the full volume. Therefore, at any touch on the screen in any vertical location, the horizontal location and/or dragging, may adjust the volume to the percentage calculated based on the horizontal location (percentage) of the screen. Thus, some embodiments enable the same mechanism using the vertical direction as the volume meter. In this way users are able to very conveniently change the volume of the device with a touch or click on the screen anywhere on the screen.

For example, in one aspect, a method includes presenting a user interface on a device with a touch sensitive grid including horizontal x coordinates, and vertical y coordinates as part of the touch sensitive grid, where the volume level of the device is indicated as a percentage relative to the horizontal x coordinate indicated by a user touch anywhere on the screen. Taking into account the horizontal x coordinate, and upon receiving a touch input on the device, the device may change the volume relative to the x coordinate which was previously selected as a percentage of the volume. The system therefore may function at a much faster speed as opposed to selecting several menus to change the volume, etc.

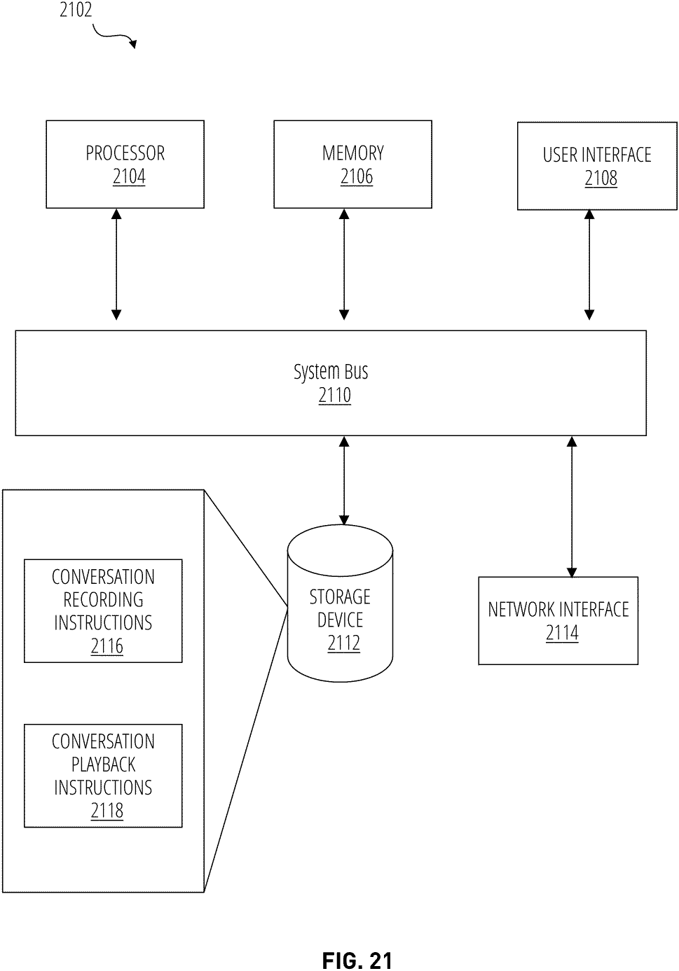

FIG. 21 is an example schematic diagram of a system 2102 according to an embodiment. The system 2102 includes a Processing Circuitry 2104 coupled to a memory 2106, a Storage Device 2112, and a network interface 2114. In an embodiment, the components of the system 2102 may be communicatively connected via a System Bus 2110.

The Processing Circuitry 2104 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 2106 may be volatile (e.g., RAM, etc.), non-volatile (e.g., ROM, flash memory, etc.), or a combination thereof. In one configuration, computer readable instructions to implement one or more embodiments disclosed herein may be stored in the storage Storage Device 2112.

In another embodiment, the memory 2106 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the Processing Circuitry 2104, cause the Processing Circuitry 2104 to perform the various processes described herein. Specifically, the instructions, when executed, cause the Processing Circuitry 2104 to record audio conversations, snippets, update, download and transmit user conversations’ elements.

The Storage Device 2112 may be magnetic storage, optical storage, and the like, and may be realized, for example, as flash memory or other memory technology, CD-ROM, Digital Versatile Disks (DVDs), or any other medium which can be used to store the desired information. Storage Device 2112 may store Conversation Recording Instructions 2116 and Conversation Playback Instructions 2118 in a non-transitory form.

The network interface 2114 allows the system 2102 to communicate with the Cloud servers 112-116 for the purpose of, for example, receiving data, sending data, and the like. Further, the network interface 2114 allows the system 2102 to communicate with the Cloud servers 112-116 for the purpose of recording conversations, snippets, and updating relationships, and communicating with Target user devices 118-122.

It should be understood that the embodiments described herein are not limited to the specific architecture illustrated in FIG. 21, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method comprising:
presenting a primary user on a primary user device with a first interface for asynchronous voice conversation transmission;
selecting a target user from the first interface;
presenting a second interface for recording a first snippet of a conversation;
presenting the primary user an option to begin recording the first snippet of the conversation;
receiving a selection by the primary user to begin recording the first snippet of the conversation;
recording the first snippet of the conversation to an audio data file and updating the second interface in response to the primary user’s speech;
receiving a selection from the primary user to stop recording of the first snippet of the conversation; and
automatically upon receiving selection from the primary user to stop recording of the first snippet of the conversation, transmitting to a cloud server the audio data file with a set of metadata associated with the audio data file to be stored on the cloud server and then transmitted to the target user device.

2. The method of claim 1 further comprising:
receiving a second snippet of the conversation from the cloud server which was recorded on the target user device;
presenting a notification to the primary user indicating receipt of the second snippet from the target user;
upon selection of the notification automatically retrieving the second snippet and presenting the second snippet in a third interface;
receiving a selection to play the second snippet in the third interface by the primary user;
playing back the second snippet of the conversation in the third interface;
upon finishing playback of the second snippet, automatically beginning recording of a third snippet of the conversation as a result of finishing playback; and
upon receiving a selection to finish recording of the third snippet, automatically transmitting the third snippet to the cloud server for storage and transmission to the target user device.

3. The method of claim 1 further comprising:
presenting the primary user with the first interface subsequent to the recording of the first snippet;
receiving a selection of the target user from the first interface;
presenting the second interface for recording a second snippet of the conversation by the primary user;
presenting the primary user an option to begin recording the second snippet of the conversation;
receiving a selection by the primary user to begin recording the second snippet of the conversation;
recording the second snippet of the conversation to a new audio data file; and
automatically upon receiving a selection from the primary user to stop recording of the second snippet of the conversation, transmitting to the cloud server the new audio data file with a new set of metadata associated with the new audio data file, to be stored on the cloud server and then transmitted to the target user device.

4. The method of claim 1 wherein the primary user is presented with an option to end the conversation after the first snippet or a subsequent snippet recording; and
upon receiving a selection to end the conversation, updating a conversation User Interface to include the first snippet and subsequently recorded snippets as part of a visually continuous conversation.

5. The method of claim 1 wherein presenting the primary user an option to begin recording the first snippet of the conversation includes:
presenting audio controls for the conversation including a record button, allowing the primary user to touch the screen to begin recording of the first snippet.

6. The method of claim 1 wherein storing on the cloud server further comprises:
creating a new conversation;
updating a relationship between the primary user and the target user;
adding an item document for the audio data file; and
transmitting a notification to the target user with the audio data file being transmitted.

7. The method of claim 1 wherein the metadata includes an audio length of the first snippet, the target user it is being sent to, a timestamp, and the primary user identity.

8. The method of claim 1 wherein selecting a target user from the interface further comprises:
presenting the primary user a Graphical User Interface (GUI) with an image icon for each contact of the primary user, and selecting the target user includes presenting a full screen image of the image icon on the second interface.

9. A computing apparatus comprising:
a processor; and
a memory storing instructions that, when executed by the processor, configure the apparatus to:
present a primary user on a primary user device with a first interface for asynchronous voice conversation transmission;
select a target user from the first interface;
present a second interface for recording a first snippet of a conversation;
present the primary user an option to begin recording the first snippet of the conversation;
receive a selection by the primary user to begin recording the first snippet of the conversation;
record the first snippet of the conversation to an audio data file and updating the second interface in response to the primary user’s speech;
receive a selection from the primary user to stop recording of the first snippet of the conversation; and
automatically upon receiving selection from the primary user to stop recording of the first snippet of the conversation, transmitting to a cloud server the audio data file with a set of metadata associated with the audio data file to be stored on the cloud server and then transmitted to the target user device.

10. A method comprising:
presenting a user interface on a device with a touch sensitive grid comprising horizontal x coordinates, and vertical y coordinates as part of the touch sensitive grid, where the volume level of the device is indicated as a percentage relative to the horizontal x coordinate indicated by a user touch anywhere on the screen, taking into account the horizontal x coordinate; and
upon receiving a touch input on the device, changing the volume of the device relative to the x coordinate which was previously selected as a percentage of the volume.

11. The method of claim 10 where the user interface is presented during playback of an audio file and the volume changes with respective screen touches indicating changes in volume.

12. The method of claim 11 where an icon is presented to the user at the point of touch, indicating the volume is changing.

13. The method of claim 12 where the icon is an image of a speaker.
